(19) United States
(12) Patent Application Publication
(10) Pub. No.: US 2010/0195209 A1
(43) Pub. Date: Aug. 5, 2010

(54) Method and Apparatus for Optical Bandpass and Notch Filtering, and Varying the Filter Center Wavelength

(75) Inventors: Douglas J. Brown, Midland (CA); Daniel B. Mitchell, Port McNicoll (CA); Geoffrey G. Harris, Midland (CA); Gerard M. Desroches, Penetanguishene (CA); William Conrad Stenton, Midland (CA)

Correspondence Address: HAYNES AND BOONE, LLP;IP Section, 2323 Victory Avenue, Suite 700, Dallas, TX, 75219, US

(73) Assignee: RAYTHEON COMPANY, Waltham, MA (US)

(21) Appl. No.: 12/363,527

(22) Filed: Jan. 30, 2009

(51) Int. Cl. G02B 26/00; G02B 5/28

(52) U.S. Cl. 359/578; 359/577

(57) ABSTRACT

A method and apparatus involve an optical element having a passband with a center wavelength, and filtering radiation having first and second portions that arrive along a path of travel extending to the optical element. The first portion includes radiation inside the passband, and the second portion includes radiation above and below the passband. The optical element transmits one of the first and second portions of the radiation therethrough, and reflects the other of the first and second portions of the radiation therefrom. The optical element is supported for a range of movement relative to the path of travel. As the optical element moves through the range of movement, the center wavelength changes.

### FIELD OF THE INVENTION

This invention relates in general to bandpass and notch filters and, more particularly, to optical bandpass and notch filters, including techniques for varying the center wavelength of optical bandpass and notch filters.

### BACKGROUND

In optical systems, it is often desirable to use an optical bandpass filter. Traditional optical bandpass filters are generally optimized to work over a restricted range of angles close to normal incidence. The effective bandwidth and center wavelength are essentially fixed during manufacture, and can only be tuned by a very small amount (always shorter and narrower), for example by tilting the filter relative to an incident beam. Moreover, at higher angles of incidence, the amplitude transmission deteriorates. In addition, it is often desirable to use the reflection beam from a bandpass filter. The reflection beam from a bandpass filter is a notch-filtered beam. However, the direction of travel of the notch-filtered beam changes with a change in the angle between the incident beam and the filter. Consequently, it can be difficult to align a notch-filtered beam from a traditional optical bandpass filter with other optical components of the optical system.

The types of optical bandpass filters mentioned above, for transmitting bandpass-filtered beams and reflecting notch-filtered beams, have been generally adequate for their intended purposes. However, as noted in the foregoing discussion, they have not been satisfactory in all respects.

### BRIEF DESCRIPTION OF THE DRAWINGS

A better understanding of the present invention will be realized from the detailed description that follows, taken in conjunction with the accompanying drawing, in which:

FIG. 1 is a diagrammatic view of an optical filter apparatus that embodies aspects of the invention.

FIG. 2 is a graph showing the transmittance of a filter in the apparatus of FIG. 1 with respect to unpolarized radiation at a selected angle of incidence.

FIG. 3 is a graph showing the reflectance of the filter of FIG. 1 with respect to unpolarized radiation at a selected angle of incidence.

FIG. 4 is a graph showing the transmittance of the filter of FIG. 1 with respect to unpolarized radiation at selected angles of incidence.

FIG. 5 is a graph showing the reflectance of the filter of FIG. 1 with respect to unpolarized radiation at selected angles of incidence.

FIG. 6 is a graph showing the transmittance of the filter of FIG. 1 with respect to s-polarized radiation at selected angles of incidence.

FIG. 7 is a graph showing the reflectance of the filter of FIG. 1 with respect to s-polarized radiation at selected angles of incidence.

FIG. 8 is a graph showing the transmittance of the filter of FIG. 1 with respect to p-polarized radiation at selected angles of incidence.

FIG. 9 is a graph showing the reflectance of the filter of FIG. 1 with respect to p-polarized radiation at selected angles of incidence.

FIG. 10 is a graph showing the transmittance of the filter of FIG. 1 with respect to s and p polarized radiation at selected angles of incidence.

FIG. 11 is a diagrammatic view of another optical filter apparatus that is an alternative embodiment of the optical filter apparatus shown in FIG. 1, and that embodies aspects of the invention.

FIG. 12 is a graph showing the transmittance of a filter in the apparatus of FIG. 11 with respect to unpolarized radiation at selected angles of incidence.

### DETAILED DESCRIPTION

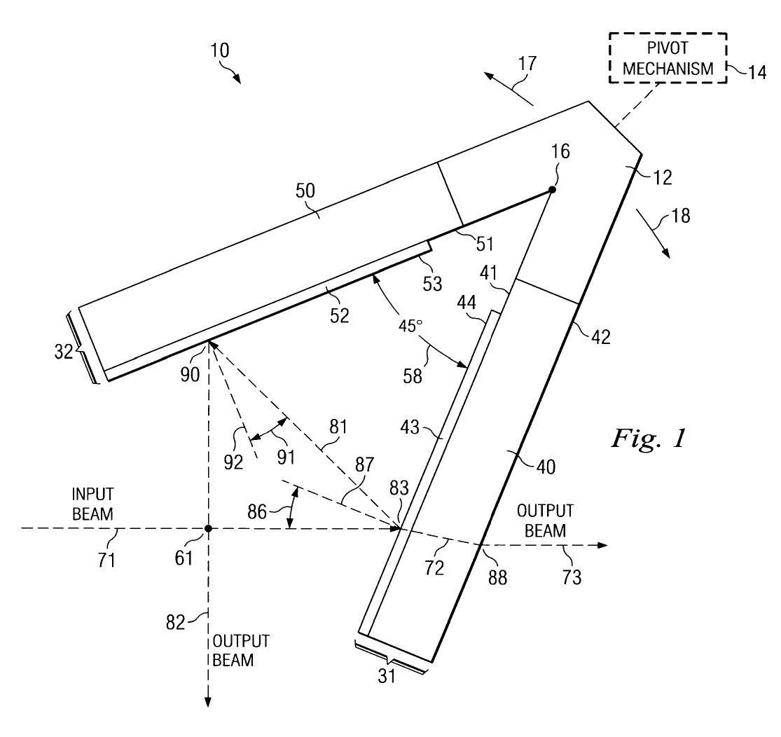

FIG. 1 is a diagrammatic view of an optical filter apparatus 10 that receives radiation as an input, filters the received radiation, and outputs respective portions of the filtered radiation along two paths of travel. In the disclosed embodiment the apparatus 10 is configured to have an operating range that is a selected portion of the spectrum between extreme ultraviolet radiation and long-wave infrared radiation. However, the apparatus 10 could be configured to have an operating range that includes some other portion of the electromagnetic spectrum.

The optical filter apparatus 10 includes a support member 12, and a pivot mechanism that is shown diagrammatically at 14. The pivot mechanism 14 supports the member 12 for limited pivotal movement about a pivot axis 16 that extends perpendicular to the plane of the drawing. In FIG. 1, the member 12 is shown in a center position. The pivot mechanism 14 can selectively pivot the member 12 a few degrees away from the illustrated center position about the axis 16, in either of two opposite directions 17 and 18. The pivot mechanism 14 can also releasably maintain the member 12 in any angular position.

The optical filter apparatus 10 includes a filter 31 and a reflective element 32 that are each of a known type, and that each have one end fixedly secured to the member 12. The filter 31 has a substrate 40 with a planar surface 41 thereon facing the reflective element 32, and with another planar surface 42 parallel to and on a side opposite from the surface 41. The filter 31 also includes a multi-layer filter coating 43 provided on the surface 41. The multi-layer filter coating 43 has a planar outer surface 44. In the disclosed embodiment, the filter 31 is a multi-cavity Fabry-Perot structure, but it could alternatively have some other suitable structure. The multi-layer filter coating 43 is transmissive to radiation inside a passband having a center wavelength, and reflective to radiation above and below the passband. Consequently, the radiation transmitted through the filter 31 is a bandpass-filtered beam and the radiation reflected from the filter 31 is a notch-filtered beam. The bandpass-filtered beam includes radiation inside the passband, and the notch-filtered beam includes radiation above and below the passband.

The reflective element 32 has a substrate 50 with a planar surface 51 thereon that faces the filter 31. The reflective element 32 also includes a mirror coating 52 provided on the surface 51. In the disclosed embodiment, the mirror coating 52 is a multi-layer design including dielectric materials. Alternatively, however, the coating 52 could be made from any other suitable material or combination of materials, and could for example be made of a metallic material. The mirror coating 52 has a planar outer surface 53. The multi-layer filter coating 43 and the mirror coating 52 are very thin but, for clarity, are shown with exaggerated thicknesses in FIG. 1. The filter 31 and the reflective element 32 are oriented so that the surfaces 41 and 51, the coatings 43 and 52, and the surfaces 44 and 53, form a 45° angle 58 with respect to each other. The pivot axis 16 is positioned at a location corresponding to an intersection of the surfaces 41 and 51. When the member 12 is in the center position shown in FIG. 1, a not-illustrated imaginary line that bisects the 45° angle 58 would intersect the pivot axis 16, and also a point 61.

Radiation can travel along a path that includes three successive sections 71, 72, and 73. Also, radiation can travel along another path that includes successive sections 81 and 82. The sections 71 and 82 intersect at the point 61. A beam of radiation enters the optical filter apparatus 10 along the path section 71. Assume for the sake of discussion that this beam is unfiltered, and includes radiation at wavelengths within the passband of the filter 31, as well as wavelengths above the passband, and wavelengths below the passband. This unfiltered beam travels along section 71 of the path of travel, which passes through the point 61, and eventually reaches the filter 31 at a location 83. The section 71 of the path of travel forms an angle 86 with respect to a line 87 that is perpendicular to the surface 44 of the filter 31 at the location 83. This angle 86 is referred to as the angle of incidence (AOI) of the radiation on the filter 31. The AOI 86 can vary, as discussed later. When the member 12 is in the center position shown in FIG. 1, the AOI 86 is 22.5°. By optimizing the filter 31 for the center position of 22.5°, the filter 31 is more sensitive to angular movement, and thus more tunable.

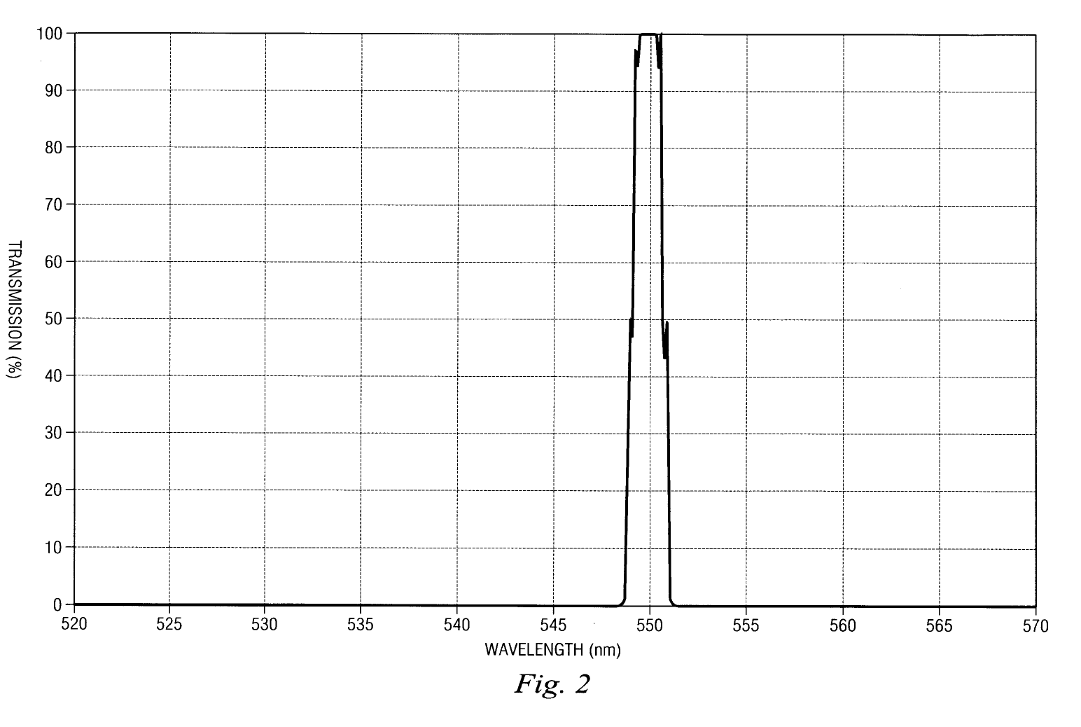

In the disclosed embodiment, wavelengths inside the passband of the filter 31 are transmitted through the filter 31 along the path section 72. Refraction occurs as the transmitted radiation passes through the filter 31, and causes the path section 72 to extend at an angle to the path section 71. When this transmitted radiation passes through the surface 42 at a location 88, the radiation refracts again such that the path section 73 is substantially parallel to the path section 71. This transmitted radiation (the bandpass-filtered beam) then exits the filter 31 at the location 88 and travels along the path section 73. For example, FIG. 2 is a graph showing the transmittance of the filter 31 with respect to unpolarized radiation when the AOI 86 is 22.5°. When the AOI 86 is 22.5°, the member 12 is in its center position. FIG. 2 shows that for an AOI of 22.5°, the passband of the filter 31 is between about 549 nm and 551 nm, and the center wavelength of the passband is at about 550 nm. Moreover, FIG. 2 illustrates that the filter 31 is approximately 100% transmissive to radiation with wavelengths between 549 nm and 551 nm, and approximately 0% transmissive (or said another way, approximately 100% reflective) to radiation below 549 nm and above 551 nm. The ranges of wavelengths for which the filter 31 is approximately 0% transmissive are known as extinction bands.

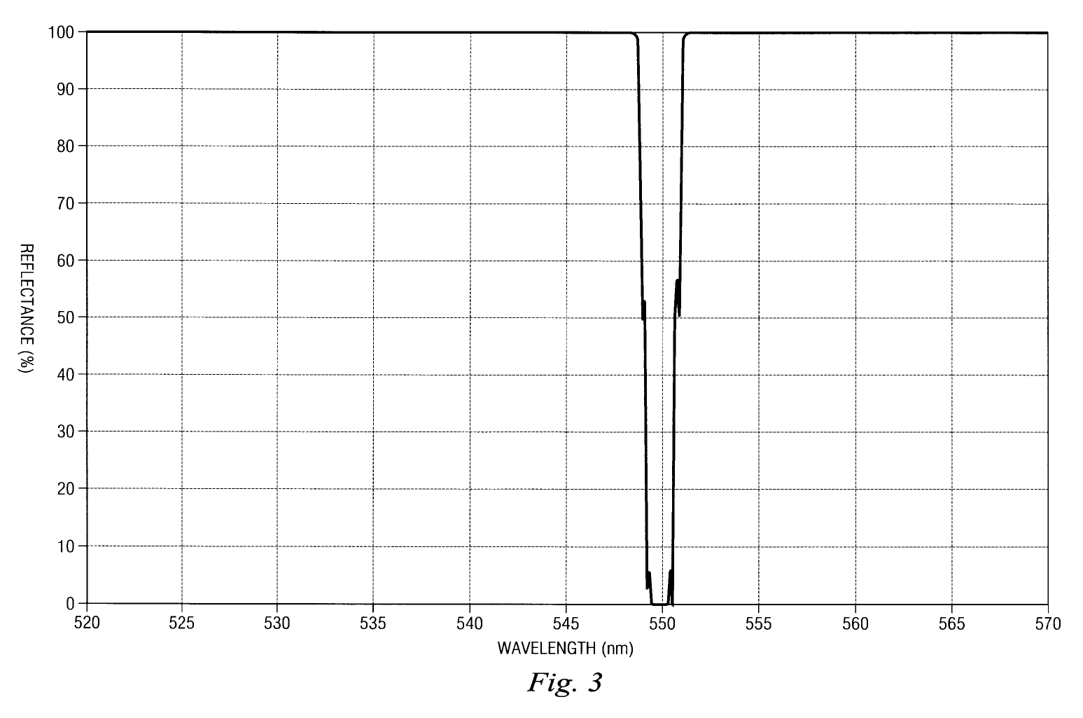

Wavelengths that are traveling along path section 71 and that are above and below the passband are reflected by the filter 31 at the location 83, and then travel along the path section 81 of the other path of travel to a location 90 on the reflective element 32. The path section 81 of the path of travel forms an AOI 91 with respect to a line 92 perpendicular to the surface 53 of the reflective element 32 at the location 90. FIG. 3 is a graph showing the reflectance of the filter 31 with respect to unpolarized radiation when the AOI 86 is 22.5°. The graph of FIG. 3 is the inverse of the graph of FIG. 2. For example, at wavelengths having an approximately 100% transmittance through the filter 31, the reflectance at the same angle of incidence is approximately 0%. Conversely, at wavelengths having an approximately 0% transmittance, the reflectance is approximately 100%. In further detail, FIG. 3 shows that for an AOI 86 of 22.5°, the passband of the filter 31 is between about 549 nm and 551 nm, and the center wavelength of the passband is at about 550 nm. Moreover, FIG. 3 shows that the filter 31 is approximately 100% reflective to radiation with wavelengths below 549 nm and above 551 nm, and approximately 0% reflective (or said another way, approximately 100% transmissive) to radiation between 549 nm and 551 nm.

In the disclosed embodiment, the reflective element 32 is capable of reflecting all wavelengths within the operating range of the optical filter apparatus 10. As discussed above, the apparatus 10 in the disclosed embodiment is configured to have an operating range that is a portion of the spectrum between extreme ultraviolet and long-wave infrared, depending on the materials used for the substrate 40, and the coatings 43 and 52. The filter 31 has already transmitted wavelengths that are inside the passband, and only wavelengths above and below the passband are reflected along the path section 81 to the reflective element 32. Consequently, as a practical matter, the only radiation actually reflected by the reflective element 32 is radiation containing wavelengths that are above and below the passband of the filter 31. These reflected wavelengths above and below the passband then travel along the path section 82, which passes through the point 61. This reflected radiation (the notch-filtered beam) then exits the optical filter apparatus 10 by continuing to propagate along the path section 82. Although two different beams of radiation exit the disclosed apparatus (the bandpass-filtered beam at path section 73 and the notch-filtered beam at path section 82), it would alternatively be possible to modify the disclosed apparatus by adding a beam dump positioned to receive and absorb one of the two beams, so that only the other beam exits the apparatus.

As discussed earlier, the pivot mechanism 14 can effect a few degrees of pivotal movement of the member 12, the filter 31 and the reflective element 32 about the pivot axis 16, in either of the directions 17 and 18. As this pivotal movement occurs, the sections 71 and 82 of the paths of travel will remain in the same positions shown in FIG. 1, in part because the pivot axis 16 has intentionally been located at a position corresponding to an intersection of the surfaces 41 and 51. Also, since the sections 71 and 82 of the paths of travel do not move as pivotal movement occurs, there is no need to effect optical realignment of the notch-filtered beam traveling along path section 82 in relation to other optical components. On the other hand, during pivotal movement of the member 12, the filter 31, and the reflective element 32, the position of the section 81 of the path of travel will change slightly.

As discussed earlier, the pivot mechanism 14 can effect a few degrees of pivotal movement of the member 12, and the AOIs 86 and 91 will each change. In particular, if the member 12 with the filter 31 and the reflective element 32 is pivoted counterclockwise in the direction 17, the AOI 86 will decrease, and the AOI 91 will increase. Conversely, if the member 12 with the filter 31 and the reflective element 32 is pivoted clockwise in the direction 18 about the axis 16, the AOI 86 will increase and the AOI 91 will decrease. Due to these changes in the AOIs 86 and 91, the passband and center wavelength of the filter 31 will change, as discussed in more detail below.

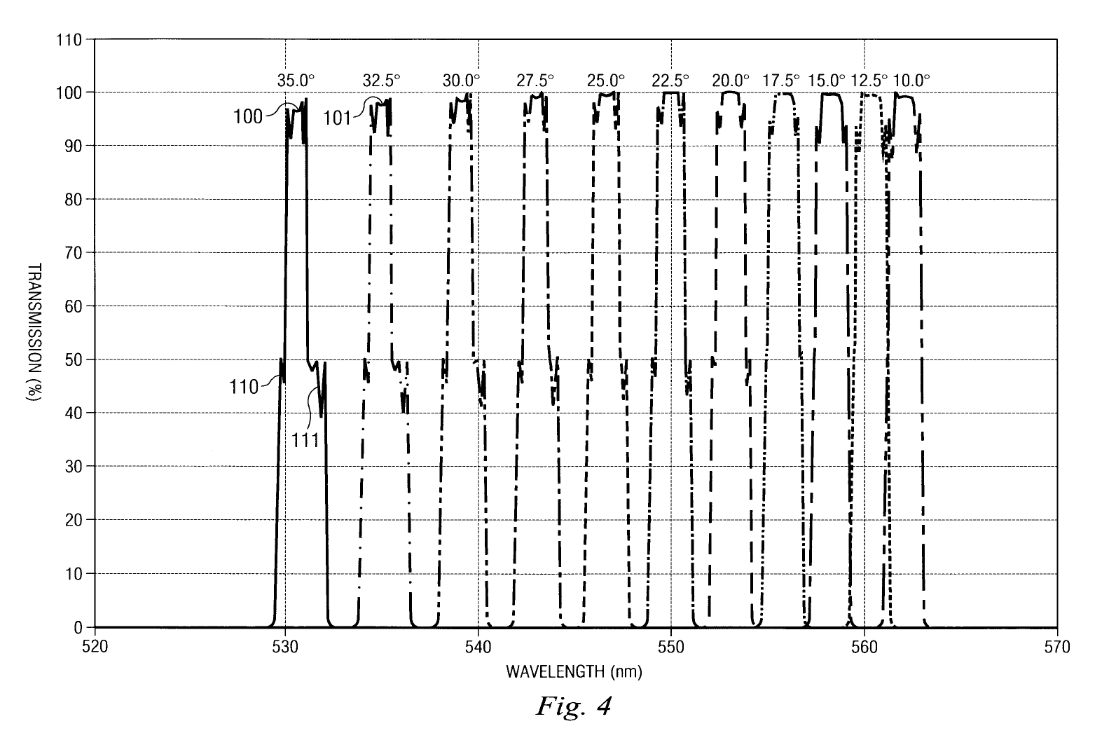

FIG. 4 is a graph showing the transmittance of the filter 31 with respect to unpolarized radiation at selected different AOI 86. It is an inherent characteristic of the multi-layer filter coating 43 that, as the AOI 86 varies, the passband of the filter 31 will shift. FIG. 4 shows eleven curves that each represent the filtering characteristic of the filter 31 at a respective different AOI 86. One of the curves shown in FIG. 4 is labeled to indicate that it corresponds to an AOI 86 of 22.5°, when the member 12 is in the center position shown in FIG. 1. This curve is the same curve shown in FIG. 2. Other curves in FIG. 4 show the transmissivity of the filter 31 at other AOIs.

FIG. 4 shows that as the AOI 86 varies, the passband and extinction bands of the filter 31 will shift together within the optical spectrum. In particular, as the AOI 86 varies through a range of about 25°, the passband will shift up or down in the spectrum, such that the center wavelength of the passband of the filter 31 varies from a wavelength of about 530.5 nm up to a wavelength of about 562 nm. As an example, when the AOI 86 is 35°, the center wavelength of the passband of the curve 100 is about 530.5 nm. When the AOI 86 is 32.5°, the center wavelength of the passband of the curve 101 is about 535 nm.

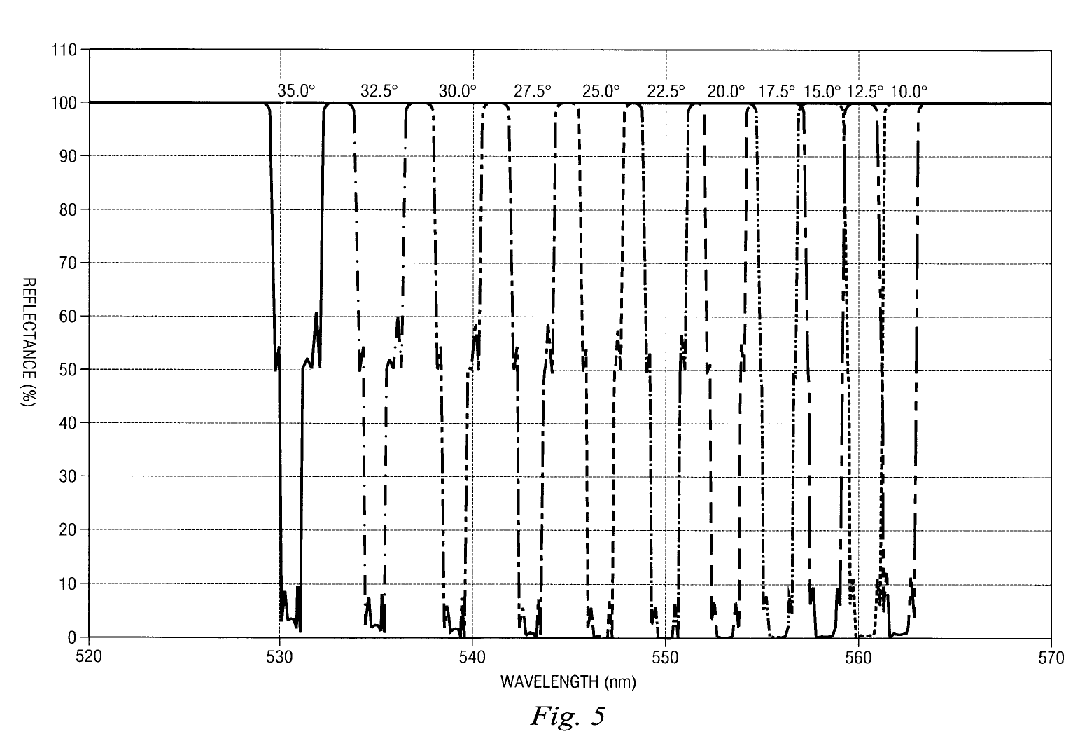

FIG. 5 is a graph showing the reflectance of the filter 31 with respect to unpolarized radiation at selected angles of incidence, and is the inverse of the graph in FIG. 4 that shows the transmittance of the filter 31. One of the curves shown in FIG. 4 is labeled to indicate that it corresponds to an AOI 86 of 22.5°, when the member 12 is in the center position shown in FIG. 1. This curve is the same curve shown in FIG. 3. Other curves in FIG. 5 show the reflectance of the filter 31 at other AOIs.

As the center wavelength of the passband shifts for transmitted radiation traveling along path section 73, the radiation reflected by the filter 31 along path sections 81 and 82 shifts in unison. Referring back to the previous examples given for the AOI 86, when the AOI 86 is 35°, the passband shown in FIG. 4 ranges from about 530 nm to 532 nm. Accordingly, FIG. 5 shows 100% reflection of radiation below about 530 nm and above about 532 nm when the AOI 86 is 35°. Moreover, when the AOI 86 is 32.50, the passband ranges from about 534 nm to 536 nm. Accordingly, FIG. 5 shows 100% reflection of radiation below about 534 nm and above about 536 nm, and approximately 0% reflection between about 534 nm and 536 nm when the AOI 86 is 32.5°.

When the AOI 86 is small, mixing of the s-polarized and p-polarized components of the transmitted radiation does not produce problems. However, as the AOI 86 becomes larger, the s-polarized and p-polarized components of the transmitted radiation begin to mix in a manner creating aberrations that can be seen in FIGS. 4 and 5. For example, when the AOI 86 is 35°, FIG. 4 shows aberrations 110 and 111 that are a result of the mixing of the s-polarized and p-polarized components of the transmitted radiation. When the AOI 86 is 10°, such aberrations are practically absent from the transmitted radiation.

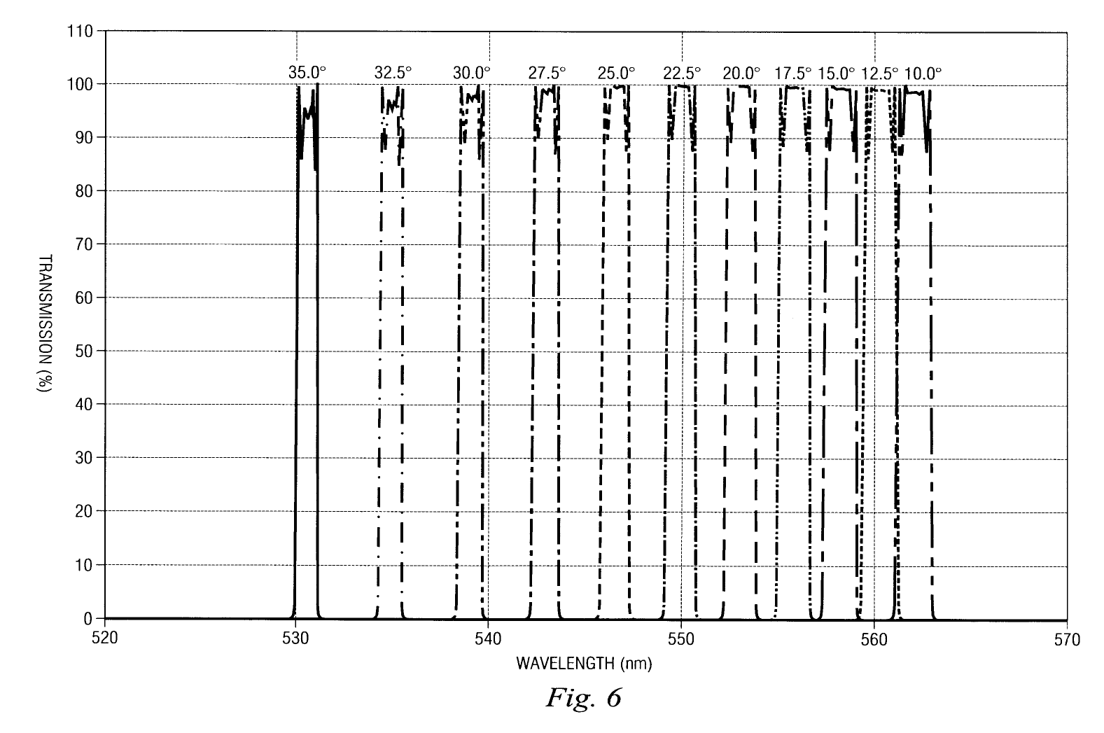

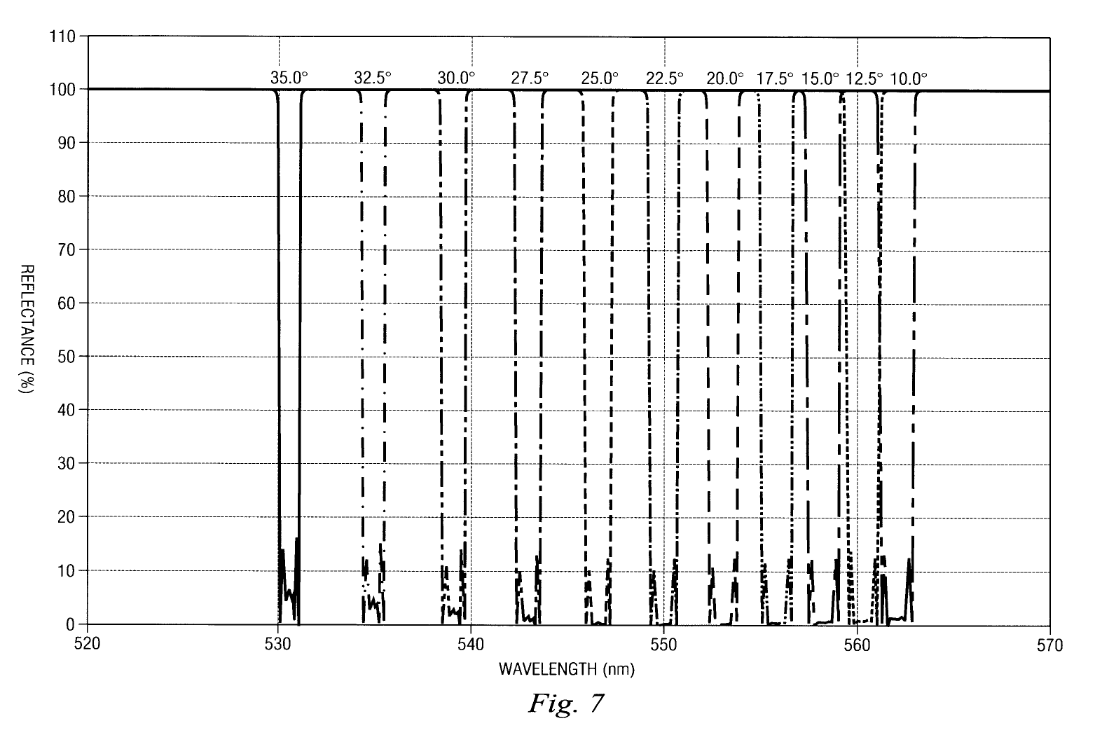

Assume that the input radiation entering at 71 is s-polarized radiation rather than unpolarized radiation. FIG. 6 is a graph showing the transmittance of the filter 31 with respect to s-polarized radiation at selected angles for the AOI 86. The graph of FIG. 6 is similar to the graph of FIG. 4, except that it shows the transmittance of s-polarized radiation instead of unpolarized radiation. FIG. 7 is a graph showing the reflectance of the filter 31 with respect to s-polarized radiation at selected angles of incidence, and is the inverse of the graph in FIG. 6 that shows the transmittance of the filter 31 with respect to s-polarized radiation.

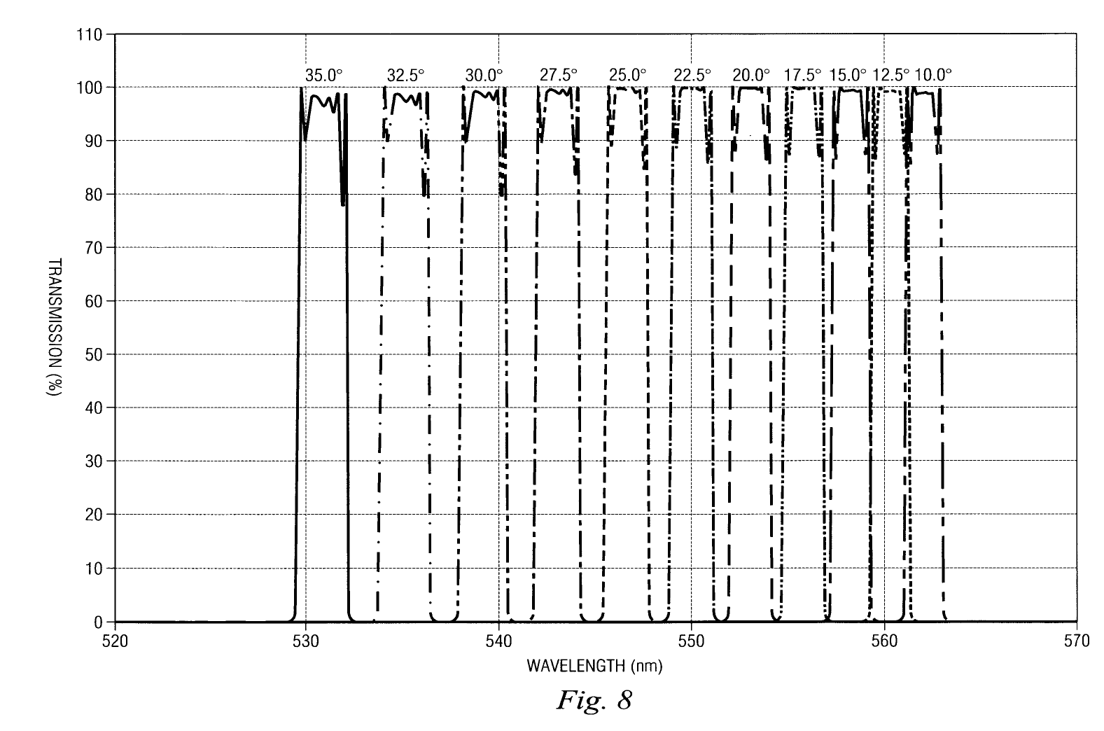

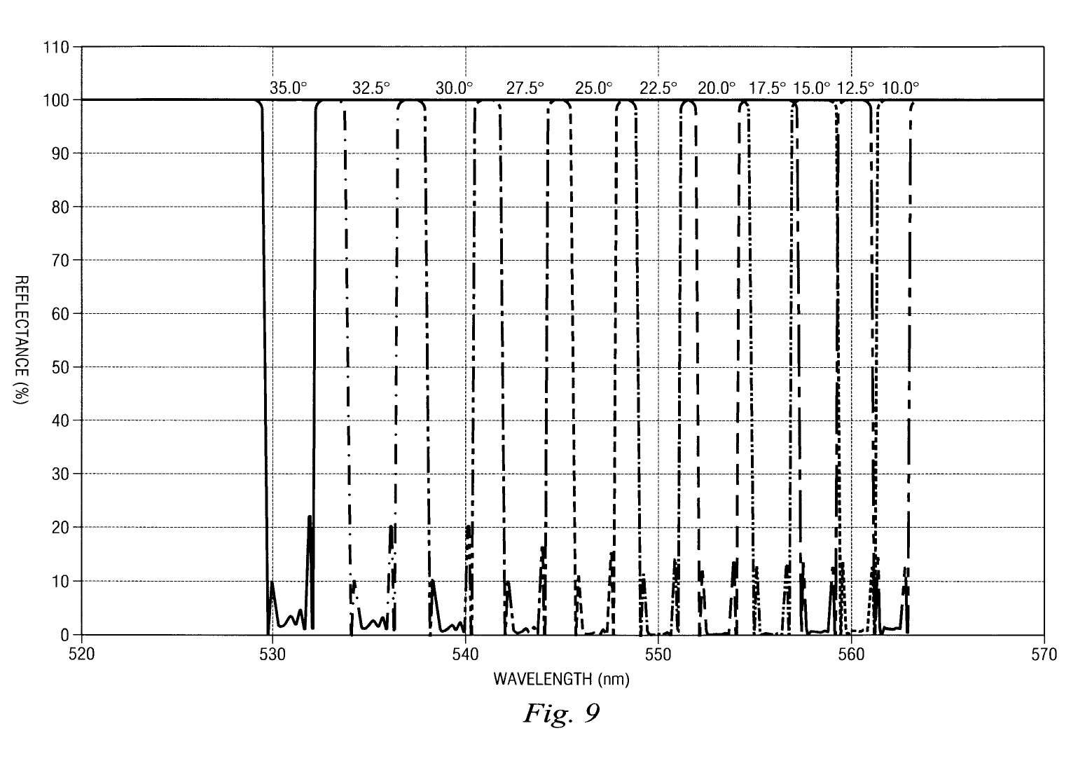

Now assume that the input radiation entering at 71 is p-polarized radiation rather than unpolarized radiation or s-polarized radiation. FIG. 8 is a graph showing the transmittance of the filter 31 with respect to p-polarized radiation at selected different AOI 86. The graph of FIG. 8 is similar to the graphs of FIGS. 4 and 6, except that it shows the transmittance of p-polarized radiation instead of unpolarized radiation and s-polarized radiation, respectively. FIG. 9 is a graph showing the reflectance of the filter 31 with respect to p-polarized radiation at selected angles of incidence, and is the inverse of the graph of FIG. 8 that shows the transmittance of the filter 31 with respect to p-polarized radiation.

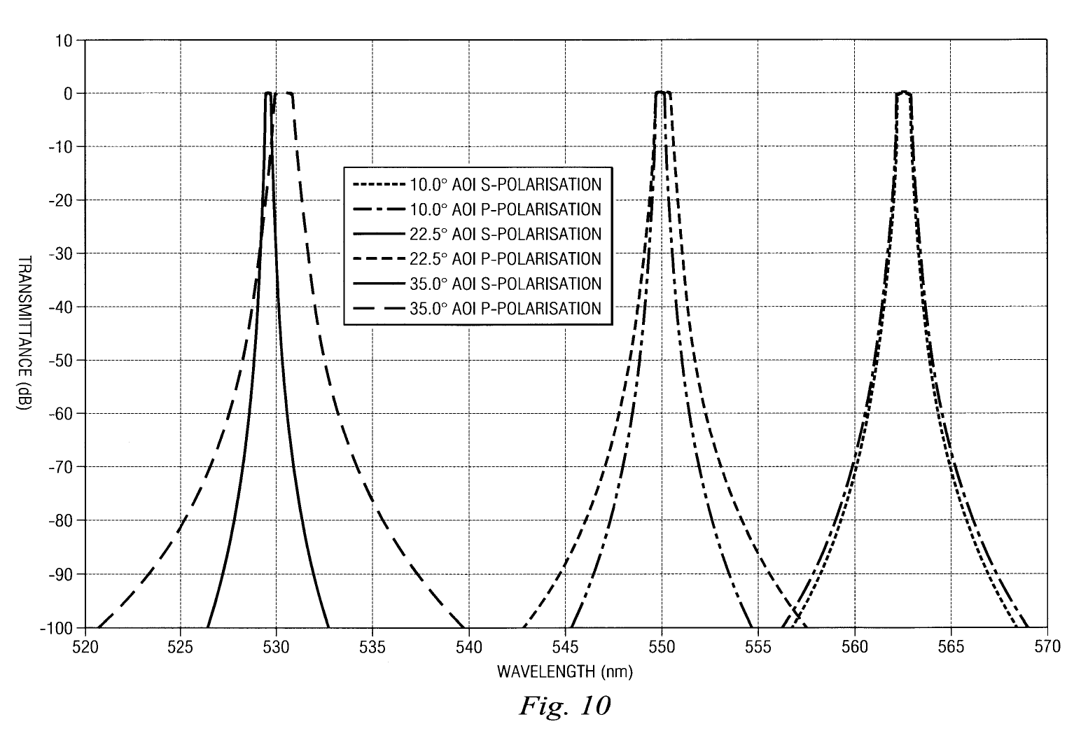

It is an inherent characteristic of the multi-layer filter coating 43 that, at selected angles for the AOI 86, the passband is wider for p-polarized radiation (FIG. 8) than for s-polarized radiation (FIG. 6). Thus, the width of the passband can also be varied by changing the polarization of the input radiation supplied to the apparatus 10 at 71. The comparison of passband widths for s and p polarization is even more clearly shown in FIG. 10, discussed below.

FIG. 10 is a graph showing the transmittance of the filter 31 with respect to s-polarized and p-polarized radiation at selected different AOI 86. FIG. 10 uses a logarithmic scale for the vertical axis, where the vertical axis represents transmittance. In particular, 0 dB represents 100% transmittance, −10 dB represents 10% transmittance, −20 dB represents 1% transmittance, −30 dB represents 0.1% transmittance, −40 db represents 0.01% transmittance, and so forth, all the way down to −100 dB which represents approximately 0% transmittance. Therefore, the portion of the graph in FIG. 10 ranging from −10 db to −100 dB shows in an expanded scale the transmittance between 10% and approximately 0% on the linear transmittance scale in the graphs of FIGS. 6 and 8. Consequently, FIG. 10 clearly illustrates that the passband is wider for p-polarized radiation transmitted by the filter 31 than for s-polarized radiation transmitted by the filter 31. Moreover, FIG. 10 also illustrates that the slope of the edges of the passband for s-polarized radiation is steeper than the slope of the edges of the passband for p-polarized radiation.

The reflectivity of the filter 31 is represented by the inverse of the graph in FIG. 10. Therefore, FIG. 10 shows that the spectrum of radiation reflected for s-polarized radiation is greater than the spectrum of radiation reflected for p-polarized radiation.

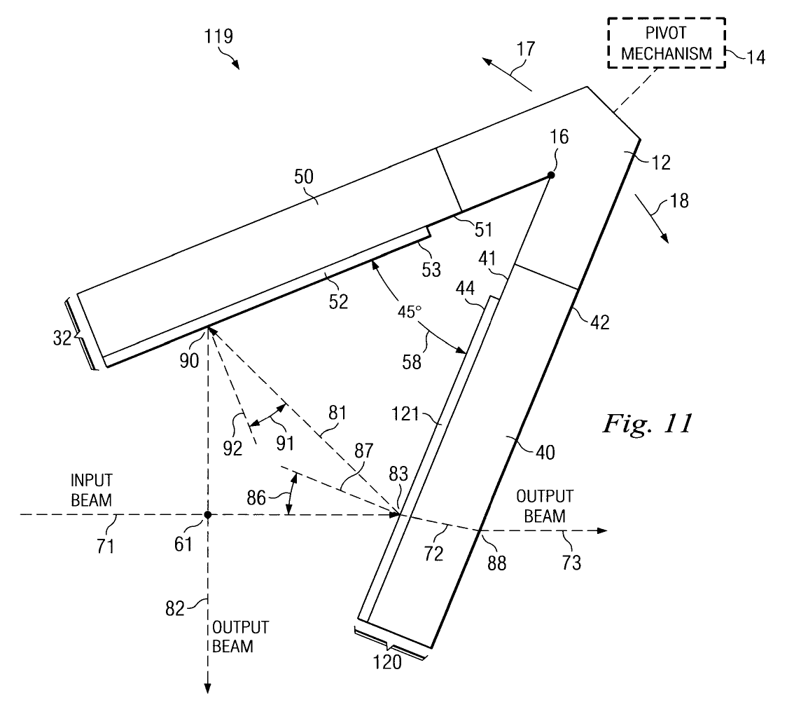

FIG. 11 is a diagrammatic view of an optical filter apparatus 119 that is an alternative embodiment of the optical filter apparatus 10 shown in FIG. 1. Identical or equivalent elements are identified by the same reference numerals, and the following discussion focuses primarily on the differences. The optical filter apparatus 119 includes a filter 120 and a multi-layer filter coating 121 that respectively replace the filter 31 (FIG. 1) and the multi-layer filter coating 43 (FIG. 1). The filter 120 operates in a manner complementary to the filter 31 (FIG. 1). The multi-layer filter coating 121 is reflective to radiation inside a passband having a center wavelength, and transmissive to radiation above and below the passband. Consequently, the radiation reflected from the filter 120 is a bandpass-filtered beam and the radiation transmitted through the filter 120 is a notch-filtered beam.

In greater detail, the notch-filtered beam is transmitted through the filter 120 along the path section 72. This transmitted notch-filtered beam then exits the filter 120 at the location 88 and travels along the path section 73. In contrast, wavelengths inside the passband are reflected by the filter 120 at the location 83, and travel along the section 81 of the other path of travel to the location 90 on the reflective element 32. In the disclosed embodiment, the reflective element 32 is capable of reflecting all wavelengths within the operating range of the optical filter apparatus 119. The filter 120 has already transmitted wavelengths that are above and below the passband, and only wavelengths inside the passband are reflected along the path section 81 to the reflective element 32. Consequently, as a practical matter, the only radiation actually reflected by the reflective element 32 is radiation containing wavelengths that are inside the passband. These reflected wavelengths inside the passband then travel along the path section 82, which passes through the point 61. This reflected radiation (the bandpass-filtered beam) then exits the optical filter apparatus 119 by continuing to propagate along the path section 82.

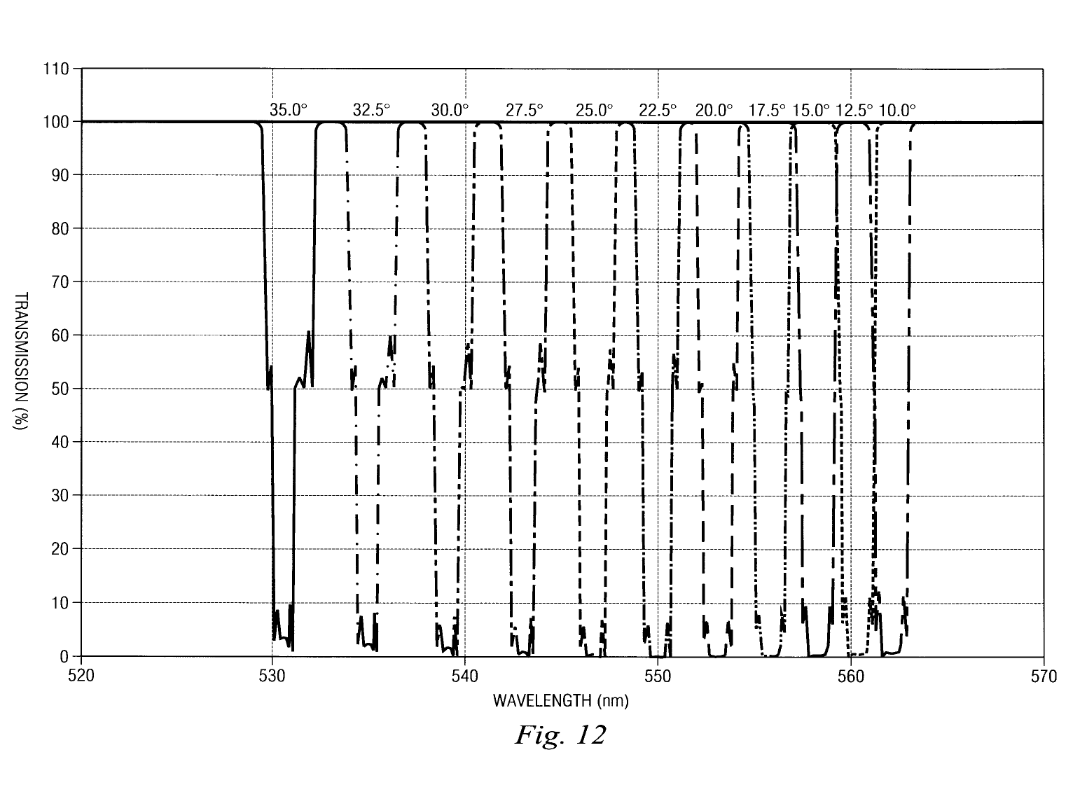

FIG. 12 is a graph showing the transmittance of the filter 120 with respect to unpolarized radiation at selected different AOI 86. It is an inherent characteristic of this type of filter 120 that, as the AOI 86 varies, the passband of the filter 120 will shift. In particular, FIG. 12 shows that, as the AOI 86 varies through a range of about 25°, the center wavelength of the passband of the filter 120 will vary.

As noted above, the graph of FIG. 12 corresponds to a situation where the radiation entering the apparatus 119 at 71 is unpolarized radiation. By way of analogy to the discussion above of the embodiment of FIGS. 1-10, it will be recognized that if the radiation entering the apparatus 119 at 71 is polarized radiation, the polarized radiation can narrow or broaden the effective width of the passband.

Although selected embodiments have been illustrated and described in detail, it should be understood that a variety of substitutions and alterations are possible without departing from the spirit and scope of the present invention, as defined by the claims that follow.

What is claimed is:

1. An apparatus comprising:
an optical element disposed along a path of travel for radiation, and filtering radiation having first and second portions and arriving along a first section of said path of travel, said first section extending to a first location at said optical element, said path of travel further having a second section extending from said first location through said optical element to a second location at said optical element, and a third section extending away from said second location, said optical element having a passband with a center frequency, being transmissive to one of said first and second portions of radiation, and being reflective to the other of said first and second portions of said radiation, said first portion being radiation inside said passband, and said second portion being radiation above and below said passband, wherein radiation to which said optical element is transmissive travels along said second and third sections of said path of travel, and radiation reflected by said optical element travels along a further path of travel; and
structure supporting said optical element for a range of movement relative to said path of travel, wherein said center wavelength changes as said optical element moves through said range of movement.

2. An apparatus according to claim 1, wherein said structure includes a pivot mechanism supporting said optical element, said range of movement being a range of pivotal movement about a pivot axis, said center wavelength decreasing as said optical element moves about said pivot axis in a first direction, and said center wavelength increasing as said optical element moves about said pivot axis in a second direction opposite said first direction.

3. An apparatus according to claim 2,
including a reflective element that is reflective to radiation reflected from said optical element and arriving along a fourth section of said further path of travel, said fourth section extending from said first location to a third location at said reflective element, said reflective element reflecting radiation traveling along said fourth section so that it thereafter travels along a fifth section of said further path of travel, said fifth section extending away from said third location; and
wherein said structure supports said reflective element for a range of movement relative to said further path of travel.

4. An apparatus according to claim 3, wherein said pivot mechanism supports said reflective element so that it moves simultaneously about said pivot axis with said optical element in relation to said paths of travel, said fifth section remaining substantially stationary as said optical element and said reflective element pivot about said pivot axis, and said third section remains substantially parallel to said first section as said optical element and said reflective element pivot about said pivot axis.

5. An apparatus according to claim 3,
wherein said first and fifth sections intersect at a point; and
wherein said pivot axis is normal to an imaginary plane containing each of said first and fifth sections.

6. An apparatus according to claim 3, wherein said optical element is reflective to said first portion of radiation, said first portion of radiation arriving at said first and third locations being reflected along said fourth and fifth sections respectively, and said second portion of radiation arriving at said first location being transmitted through said optical element along said second section to said second location.

7. An apparatus according to claim 3, wherein said optical element is transmissive to said first portion of radiation, said second portion of radiation arriving at said first and third locations being reflected along said fourth and fifth sections respectively, and said first portion of radiation arriving at said first location being transmitted through said optical element along said second section to said second location.

8. An apparatus according to claim 3,
wherein said optical element has substantially planar and parallel first and second surfaces thereon, said first location being disposed at said first surface, and said second location being disposed at said second surface;
wherein said third section is substantially parallel to said first section;
wherein said reflective element has a substantially planar third surface thereon, said third location being disposed at said third surface; and
wherein said first and third surfaces are oriented at a predetermined angle with respect to each other.

9. An apparatus according to claim 3,
wherein said radiation arriving at said first location has one of first and second polarizations, said first polarization being different from said second polarization; and
wherein a width of said passband is greater for radiation arriving at said first location with said first polarization than for radiation arriving at said first location with said second polarization.

10. An apparatus according to claim 1, wherein said optical element produces extinction bands above and below said passband, said extinction bands shifting with said center wavelength as said optical element moves through said range of movement.

11. An apparatus according to claim 1,
wherein said optical element has substantially planar and parallel first and second surfaces thereon, said first location being disposed at said first surface, and said second location being disposed at said second surface; and
wherein said third section is substantially parallel to said first section.

12. An apparatus according to claim 11, wherein said optical element includes a substrate having thereon one of a bandpass filter coating and a notch filter coating, said first surface being provided on said one of said bandpass filter coating and said notch filter coating.

13. A method comprising:
causing radiation having first and second portions to propagate along a first section of a path of travel extending to a first location at an optical element having a passband with a center wavelength, said path of travel further having a second section extending from said first location through said optical element to a second location at said optical element, and a third section extending away from said second location, said first portion being radiation inside said passband, and said second portion being radiation above and below said passband;
transmitting one of said first and second portions of said radiation through said optical element along said second and third sections of said path of travel;
reflecting at said optical element the other of said first and second portions of said radiation; and
supporting said optical element for a range of movement relative to said path of travel, said center wavelength changing as said optical element moves through said range of movement.

14. A method according to claim 13, wherein said supporting of said optical element includes supporting said optical element for pivotal movement about a pivot axis through said range of movement, said center wavelength decreasing as said optical element moves about said pivot axis in a first direction, and said center wavelength increasing as said optical element moves about said pivot axis in a second direction opposite said first direction.

15. A method according to claim 14,
including causing said other of said first and second portions of radiation, after reflection at said optical element, to propagate along a further path of travel and to arrive at a reflective element along a fourth section of said further path of travel, said fourth section extending from said first location to a third location at the reflective element, said reflective element reflecting radiation traveling along said fourth section so that it thereafter travels along a fifth section of said further path of travel, said fifth section extending away from said third location; and
supporting said reflective element for a range of movement relative to said further path of travel.

16. A method according to claim 15, wherein said supporting of said reflective element includes supporting said reflective element for pivotal movement so that it moves simultaneously with said optical element about said pivot axis in relation to said paths of travel, said fifth section remaining substantially stationary as said optical element and said reflective element pivot about said pivot axis, and said third section remains substantially parallel to said first section as said optical element and said reflective element pivot about said pivot axis.

17. A method according to claim 15,
including arranging said paths of travel so that said first and fifth sections intersect at a point; and
wherein said pivot axis is normal to an imaginary plane containing each of said first and fifth sections.

18. A method according to claim 15,
including selecting said second portion as said one of said first and second portions; and
selecting said first portion as said other of said first and second portions.

19. A method according to claim 15,
including selecting said first portion as said one of said first and second portions; and
selecting said second portion as said other of said first and second portions.

20. A method according to claim 15,
including configuring said optical element to have substantially planar and parallel first and second surfaces thereon, said first location being disposed at said first surface, and said second location being disposed at said second surface;
wherein said third section is substantially parallel to said first section;
wherein said reflective element has a substantially planar third surface thereon, said third location being disposed at said third surface; and
wherein said supporting of said optical element and said supporting of said reflective element include orienting said first and third surfaces at a predetermined angle with respect to each other.

21. A method according to claim 1,
including producing extinction bands above and below said passband with said optical element; and
causing said extinction bands to shift with said center wavelength as said optical element moves through said range of movement.

22. A method according to claim 1,
including configuring said optical element to have substantially planar and parallel first and second surfaces thereon, said first location being disposed at said first surface, and said second location being disposed at said second surface; and
configuring said optical element so that said third section is substantially parallel to said first section.

23. A method according to claim 22,
including configuring said optical element to have a substrate having thereon one of a bandpass filter coating and a notch filter coating; and
providing said first surface on said one of said bandpass filter coating and said notch filter coating.

24. A method according to claim 23,
wherein said causing radiation to propagate along said first section includes causing radiation having one of first and second polarizations to propagate along said first section, said first polarization being different from said second polarization; and
configuring said optical element so that a width of said passband is greater for radiation arriving at said first location with said first polarization than for radiation arriving at said first location with said second polarization.
